(19) United States
(12) Patent Application Publication
(10) Pub. No.: US 2022/0340161 A1
(43) Pub. Date: Oct. 27, 2022

(54) ALWAYS-ON MOTION CONTROLLER

(71) Applicants: Steering Solutions IP Holding Corporation, Auburn Hills, MI (US); Continental Automotive Systems, Inc., Auburn Hills, MI (US)

(72) Inventor: Omkar KARVE, Farmington Hills, MI (US)

(21) Appl. No.: 17/239,738

(22) Filed: Apr. 26, 2021

(51) Int. Cl. B60W 60/00; G01C 21/34; B60W 40/08; B60W 10/20; B60W 10/18; B60W 10/04; B60W 40/04; B60W 30/095

(52) U.S. Cl. CPC B60W 60/001; G01C 21/3453; B60W 40/08; B60W 10/20; B60W 10/18; B60W 10/04; B60W 40/04; B60W 30/0956; B60W 2540/229; B60W 2552/53; B60W 2554/4029

(57) ABSTRACT

In a number of illustrative variations, an always-on motion controller may include a path planner system; a driver monitoring system, and a motion controller system. The always-on motion controller may provide for an always present autonomous driving system which may seamlessly take control of the vehicle where driver attention is lost, distracted, or momentarily absent. The always-on motion controller may seamlessly release control of the vehicle to the driver or driver attention is regained.

### TECHNICAL FIELD

The field to which the disclosure generally relates to includes motion controllers within vehicle steering systems.

### BACKGROUND

Autonomous driving and steering systems typically associated with self-driving vehicles may include electronic steering systems including motion controllers and path planners. Autonomous driving systems may be enabled and disabled by a driver.

### SUMMARY OF ILLUSTRATIVE VARIATIONS

A number of illustrative variations may include a method or product for handling driver attentiveness in an autonomous steering system.

An always-on motion controller may integrate an available path planner, motion controller, and driver monitoring system in a way to provide for an always present autonomous driving system which may seamlessly take control of the vehicle where driver attention is lost, distracted, or momentarily absent. The always-on motion controller may seamlessly release control of the vehicle to the driver when driver attention is regained.

A product may include an always-on motion controller; a path planner system; a driver monitoring system; and a motion controller system.

A method may include providing an integrated system including a motion controller system; a path planner system; a plurality of internal and external vehicle sensors; a driver monitoring system; and an always-on motion controller in operable communication with the path planner system, the driving monitoring system, and the motion controller system. The method may further include receiving information relating to driver attentiveness as determined by the driver monitoring system; receiving actuator status information from the motion control system; receiving predetermined path plans from the path planner system; receiving environmental information such as, but not limited to, detected drivable zones and areas, obstacles, other vehicles, pedestrians, and the like from the internal and external vehicle sensors; receiving driver intention and attention interpretation data from the driver monitoring system; determining path plans based on information received from the internal and external vehicle sensors and the driver monitoring system; and providing motion controller state data to the path planner system and actuator commands to the motion control system.

A method may include providing an integrated system including a path planner system; a plurality of internal and external vehicle sensors; a driver monitoring system; a motion controller system; and an always-on motion controller constructed and arranged to continuously provide an always present autonomous driving system constructed and arranged to seamlessly take control of a vehicle when the system has determined that driver attention is at least momentarily absent and wherein the always-on motion controller is in operable communication with the path planner system, the driving monitoring system, and the motion controller system. The method may further include receiving information relating to driver attentiveness as determined by the driver monitoring system; receiving actuator status information from the motion control system; receiving predetermined path plans from the path planner system; receiving environmental information including at least one of detected drivable zones and areas, obstacles, other vehicles, or pedestrians from the internal and external vehicle sensors; receiving driver intention and attention interpretation data from the driver monitoring system; determining path plans based on information received from the internal and external vehicle sensors and the driver monitoring system; and providing at least one of motion controller state data to the path planner system, visual and audio flags to the driver monitoring system, or actuator commands to the motion control system.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an illustrative variation of an always-on motion controller system;

FIG. 2 depicts an illustrative use case diagram employing one variation of an always-on motion controller system;

FIG. 3 depicts an illustrative use case diagram employing one variation of an always-on motion controller system;

FIG. 4 depicts an illustrative use case diagram employing one variation of an always-on motion controller system; and

FIG. 5 depicts an illustrative use case diagram employing one variation of an always-on motion controller system.

### DETAILED DESCRIPTION OF ILLUSTRATIVE VARIATIONS

The following description of the variations is merely illustrative in nature and is in no way intended to limit the scope of the invention, its application, or uses.

In a number of illustrative variations, a vehicle for cargo or passengers may be driven ahead by an automotive power derived from a motor that transforms a source of stored energy into a driving force for the vehicle such as but not limited to an internal combustion engine, a battery powered engine, a fuel-cell powered engine, or any other known motor for providing automotive driving power for a passenger or cargo vehicle. The driving force that results from the transformation of stored energy by the motor may be communicated from the motor to a driving medium along which the vehicle will travel such as but not limited to a tract of land, a road, a waterway, an airway, or any other medium along which vehicles are known to travel through space. The communication of the driving force from the motor to the driving medium may occur via any means of driven automotive vehicle movement.

As used herein, “wheels” or “wheel,” even when modified by a descriptive adjective such as but not limited to in the recitation of “steerable roadwheels,” “steerable wheels,” “road wheels,” or “driven wheels,” may refer to a traditional road wheel and tire arrangement, but may also refer to any modification to the traditional road wheel and tire arrangement such as but not limited to rimless mag-lev tires, ball tires, or any other known means of automotive movement.

As used herein, “road,” even when modified by a descriptive adjective may refer to a traditional driving surface road such as but not limited to a concrete or asphalt road but may also refer to any driving surface or medium along which or through which a vehicle for cargo or passengers may travel such as but not limited to water, ice, snow, dirt, mud, air or other gases, or space in general.

In a number of illustrative variations, a vehicle may have a steering system that allows a driver to change the vehicle's direction or divert it from a path that it may be traveling in. This steering system may operate in conjunction with a source of driven automotive vehicle movement such as a pair of driven roadwheels. As a non-limiting example, a vehicle may be equipped with an internal combustion engine that mechanically drives a pair of rear roadwheels to propel the vehicle forward along a road. In such an example, the vehicle may additionally be equipped with a set of steerable front roadwheels that may be manipulated by the steering system via a steering interface such as but not limited to a handwheel to steer the vehicle to the left and to the right as the vehicle travels down the road. In such an example, the driven rear roadwheels serve as the means of driven automotive vehicle movement, and the steerable pair of front roadwheels as manipulated by the steering interface serves as the steering system. Importantly, this is not the only means by which a vehicle is contemplated as being driven or steered in this disclosure. In a number illustrative variations the front roadwheels may be the driven roadwheels as well as the steerable roadwheels. Similarly, the means of driven automotive vehicle movement does not need to be of the same kind as the steering means. That is, if the means of driven automotive vehicle movement comprises roadwheels, the steering means does not need to also comprise roadwheels. To that end, as a non-limiting example, it is contemplated that a snowmobile may be driven by a set of treads toward the rear of the vehicle and steered by a set of steerable skis toward the front of the vehicle. Additionally, it is contemplated that the means of driven automotive vehicle movement, such as but not limited to driven roadwheels, and the steering means, such as but not limited to steerable roadwheels, may change function or oscillate in function while in operation. As a non-limiting example, a vehicle comprising a pair of driven roadwheels near the rear of the vehicle and further comprising a pair of steerable roadwheels near the front of the vehicle may change driving modes and begin to utilize every roadwheel available, including the front steerable roadwheels, as driven roadwheels while still maintaining the steerable property and steering function of the front steerable roadwheels. It is similarly contemplated that driven roadwheels may be intermittently or optionally used as steerable roadwheels in some cases.

In a number of illustrative variations, a vehicle's steering system may also be autonomous in that the vehicle may steer itself toward a predetermined location that has been communicated to it without assistance or interference from a driver. The vehicle may have an obstacle avoidance system that allows the vehicle to sense objects in its path and avoid them. In some cases, the driver of the vehicle may wish to assist the vehicle in avoiding an object, or to change direction of the vehicle without first communicating that wish to the vehicle in some other manner. In such a case, the driver may take control of the driver-side steering system controls and assist the autonomous steering system.

In a number of illustrative variations, an autonomous driving system may be programmed with any number of logic modules arranged to autonomously address a number of areas of control within the realm of vehicle steering and travel including but not limited to vehicle acceleration, vehicle braking, and an autonomous steering system for at least lateral control of the vehicle. The logic for the modules of the autonomous steering system may account for driver assistance or intervention.

An always-on motion controller may utilize an integrated systems approach wherein various systems involved in an autonomous vehicle will be used to create the motion control signals for the engine, braking, and steering systems. The always-on motion controller may be in operable communication with a path planner system, a driver monitoring system, and a motion control system which may be continuously running. The path planner may monitor which lane the driver is driving in or keep track of present traffic situation around the vehicle even if the driver is manually driving. The driver monitoring system may provide driver attentiveness information to the always-on motion controller. The motion control system may monitor and track the current state of the vehicle and actuators. If the driver monitoring system has determined that driver has momentarily lost concentration and is not able to input actuator commands from wheels and pedals then the always-on motion controller may seamlessly accept path planner commands and send actuator commands overriding or assisting driver's inputs enabling safe operation of the vehicle in the given traffic situation while maintaining current mission.

In a number of illustrative variations, a vehicle may include an autonomous driving system integrating various systems to provide always-on functionality in which the autonomous driving system is continuously monitoring vehicle parameters such as speed, steering angle, and the like. The system may be constructed and arranged to create motion control signals for systems within a vehicle such as engine systems, brake systems, and steering systems.

A path planning system may monitor vehicle lane spacing as well as surrounding traffic conditions relative to the vehicle. As a non-limiting example, the path planning system may, through a number of sensors, cameras, and other monitoring systems, observe and monitor road lane indicators, adjacent vehicles, and nearby obstructions in the operating environment other vehicle. The path planning system may calculate or determine a planned trajectory for a vehicle while in autonomous driving mode. The planned trajectory may include providing commands to the motion control system or another system within the autonomous driving vehicle.

A motion control system may include at least one controller or computing device constructed and arranged to be an operable communication with a plurality of actuators associated with the engine system, brake system, and steering system of the vehicle. The motion control system may provide actuator commands to the engine system, brake system, and steering system to facilitate control of the vehicle.

A driver monitoring system may monitor and determine driver attentiveness information. The driver monitoring system may have always-on functionality in that the driver monitoring system is continuously monitoring and determining driver concentration levels. In combination with motion control system states and trajectory objectives, the always-on motion controller may send counter or assisting motion control signals to actuators to maintain trajectory or objective to assist a driver. As a non-limiting example, a driver monitoring system may utilize a number of sensors, cameras, and other monitoring systems to observe the vehicle driver to detect for driver distraction, reduced concentration, and momentary lapses in attention. Driver attentiveness may be monitored by observing driver head position, eye and eyelid movement, limb and extremity movement, among other things. If the driver monitoring system has determined that a driver has lost concentration and is not, cannot, or will not provide vehicle command in the form of turning the road wheel or pedals, then the driver monitoring system may accept commands from the path planning system and provide said commands to the motion control system such that user control of the vehicle is overridden during the temporary distraction. The driver monitoring system may provide for continuous monitoring of the operating environment and vehicle environment and safe operation of the vehicle in various situations where driver distraction is present.

The always-on motion controller may integrate inputs from the driver monitoring system, the path planning system, and the motion control system. The always-on motion controller may be constructed and arranged to determine when to send actuator commands to an electronic steering system if the driver's inputs are contrary to the safe operation of the vehicle and the trajectory predicted due to current steering input creates an unsafe driving condition. The always-on motion controller may be constructed and arranged to determine when a driver has lost concentration, is not paying attention, is incapacitated, or is otherwise unable to safely pilot the vehicle. Based upon current and past information obtained from the vehicle sensors such as GPS location, speed, steering angle, and the like, the always on motion controller and path planner may continuously maintain at least one future predicted path generated to match that which has been interpreted as the driver's intended path or driver intention. This may be used to continue to drive the vehicle on the driver's intended path when the driver may be momentarily inattentive and the always on motion controller is operating the vehicle. The always-on motion controller may be constructed and arranged to provide steering actuator commands, brake system commands, an engine system commands where the always-on motion controller has determined that the driver has lost concentration and driver inputs are creating unsafe conditions.

In a number of illustrative variations, the driver monitoring system may determine that sending actuator commands to the motion control system and steering system is necessary to override driver input contrary to the safe operation of the vehicle as determined by the path planning system. In a number of illustrative variations, while the vehicle is steering autonomously according to a predetermined vehicle path, if the driver attempts to divert the travel of the vehicle from the predetermined path by manipulating a steering interface of the vehicle in an attempt to steer the vehicle, the autonomous steering system may override driver input contrary to the safe operation of the vehicle as determined by the path planning system. As a non-limiting example, if the autonomous steering system is steering on a straight-forward bearing in a particular lane in accordance with a predetermined vehicle path, and the driver intervenes by attempting to steer the vehicle away from the straightforward bearing by applying force to a steering interface, the autonomous steering system may override driver input contrary to the safe operation of the vehicle which may include preventing the driver from overriding the autonomous steering system.

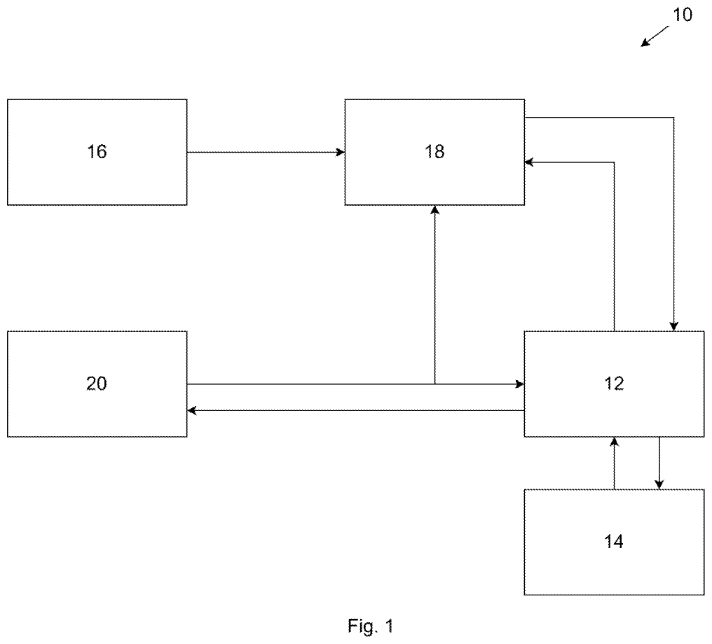

Referring to FIG. 1, as a non-limiting example, an integrated system 10 may include an always-on motion controller 12, a path planner system 18, a plurality of internal and external vehicle sensors 16, a driver monitoring system 20, and a motion controller system 14 for lateral and longitudinal actuation. The always-on motion controller 12 may receive a variety of information from the systems within the integrated system 10. The always-on motion controller 12 may receive information relating to driver attentiveness as determined by the driver monitoring system 20. The always-on motion controller 12 may receive actuator status information from the motion control system 14. The always-on motion controller 12 may receive predetermined path plans from the path planner system 18. The path planner system 18 may receive environmental information such as, but not limited to, detected drivable zones and areas, obstacles, other vehicles, pedestrians, and the like from the internal and external vehicle sensors 16. The path planner system 18 may also receive driver intention and attention interpretation data from the driver monitoring system 20. The path planner system 18 may determine path plans based on information received from the internal and external vehicle sensors 16 and the driver monitoring system 20. The always-on motion controller 12 may provide motion controller state data to the path planner system 18, visual and audio flags to the driver monitoring system 20, and actuator commands to the motion control system 14.

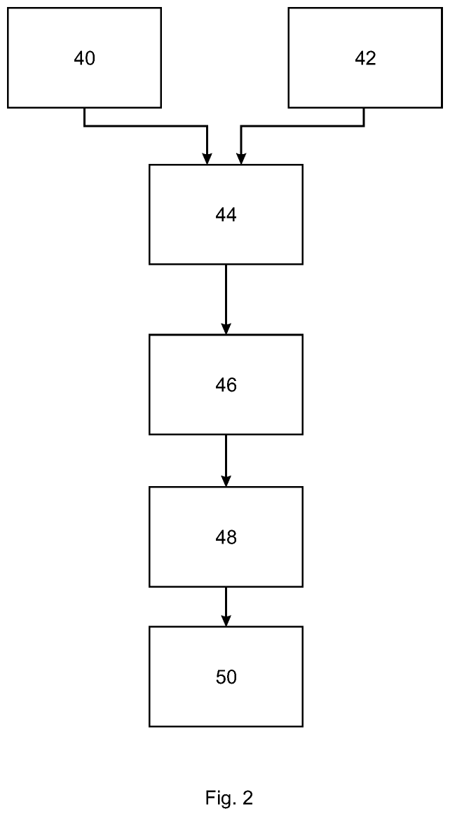

Referring to FIG. 2, as a non-limiting example, an always-on motion controller may monitor 40 a driving environment for obstacles, driving lanes, and traffic while a user is driving the vehicle. The always-on motion controller may interpret current driver intention as maintaining a specific driving lane at a specific speed. The driver traveling in a specific lane may lose attention as determined by the driver monitoring system 42. The always-on motion controller may engage actuators 44 to keep the vehicle on its interpreted trajectory and maintain current speed. The always-on motion controller may additionally warn the driver via audio and visual cues. The always-on motion controller may maintain accelerator inputs and steering torque as needed. The driver monitoring system may determine 46 that a driver has regained attention to driving. The always-on motion controller may disengage 48 steering torque and accelerator inputs and provide control back to the driver while gradually allowing the driver to control speed via an accelerator pedal. The always-on motion controller may continue to monitor 50 and interpret driver attention to maintain an intended path.

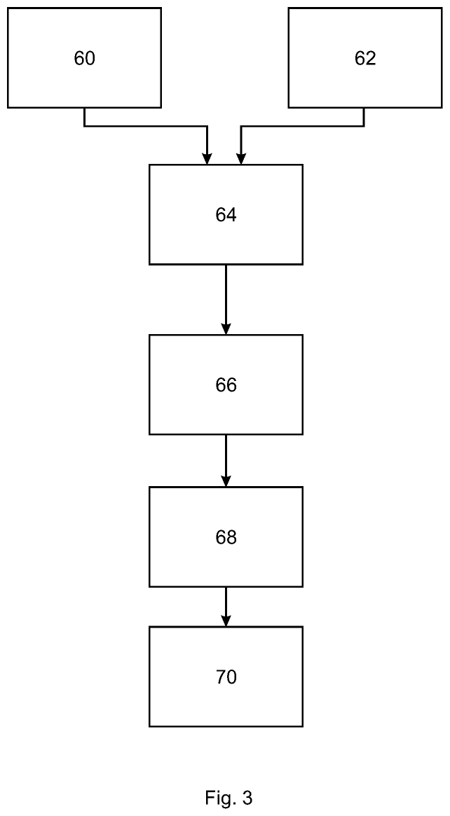

Referring to FIG. 3, as a non-limiting example, an always-on motion controller may interpret 60 that a driver's intention is to change lane of travel, for example, changing lanes to the right. The driver monitoring system may determine 62 that the driver is paying attention. The always-on motion controller may detect that the lane change is potentially unsafe but still below a predetermined safety threshold. The always-on motion controller may not engage any mitigating action 64 but provide an audio or visual cue warning the driver about the potentially unsafe lane change where the always-on motion controller has determined 66 that the predetermined safety threshold has been exceeded. The always-on motion controller may warn the driver the visual or audio cue and may reduce speed or manage inputs 68 to counter steering and acceleration to prevent a collision or an unsafe driving scenario. The always-on motion controller may continue to monitor 70 an interpret driver intention to maintain an intended trajectory.

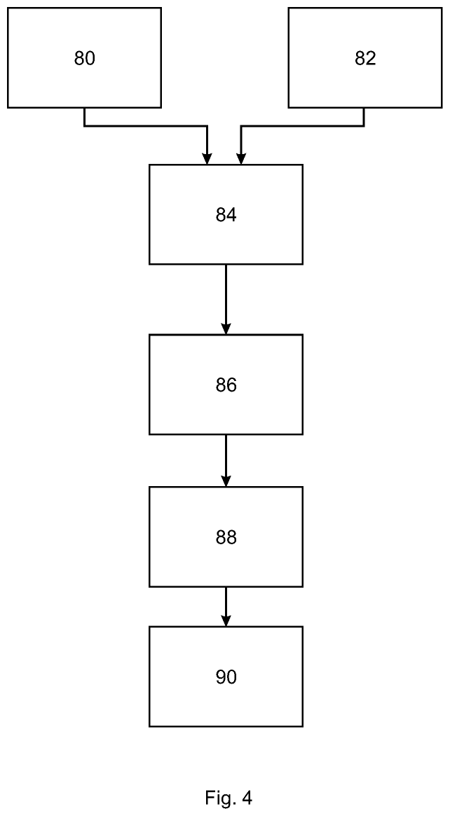

Referring to FIG. 4, as a non-limiting example, a vehicle having an always-on motion controller maybe making a right turn according to driver input and the always-on motion controller may interpret current driver intention 80 as continuing to make the right turn. The driver monitoring system may determine 82 that the driver is not paying attention while making the turn. The always-on motion controller may engage steering torque and acceleration input 84 to maintain the projected path as interpreted by the always-on motion controller. The always-on motion controller or driver monitoring system may determine 86 that the driver is now paying attention. The always-on motion controller may gradually disengage steering torque and acceleration input 88 to provide control back to the driver and to not induce sudden vehicle oscillation. The always-on motion controller may continue to monitor 90 and interpret driver intention and to maintain an intended trajectory.

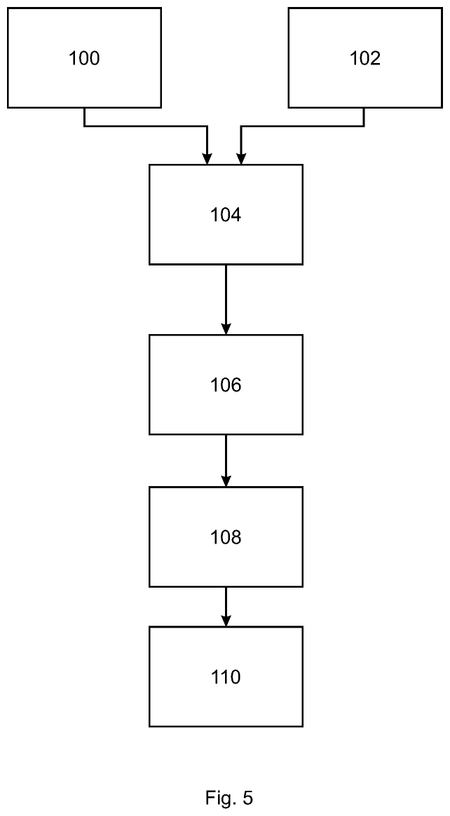

Referring to FIG. 5, as a non-limiting example, a vehicle having an always-on motion controller may be making a right turn according to driver input and they always-on motion controller may interpret current driving intent 100 as continuing to make the right turn. The driver monitoring system may determine 102 that the driver is not paying attention. The always-on motion controller may engage steering torque and acceleration input 104 to maintain the projected trajectory as interpreted by the always-on motion controller. The always-on motion controller or driver monitoring system may determine 106 that the driver is continuing to not pay attention or is incapacitated. The always-on motion controller may inform 108 the path planner to generate a safe path to a stopping zone. The always-on motion controller may bring the vehicle to a safe stop 110 as determined by the path planner.

In a number of illustrative variations, any number of modules and systems may be combined together or broken into smaller modules and systems.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

According to variation 1, a product may include an always-on motion controller; a path planner system; a driver monitoring system; and a motion controller system.

Variation 2 may include a product as set forth in variation 1, wherein the always-on motion controller is in operable communication with the path planner system, the driving monitoring system, and the motion controller system.

Variation 3 may include a product as set forth in any of variations 1 through 2, wherein the always-on motion controller is constructed and arranged to continuously provide for an always present autonomous driving system constructed and arranged to seamlessly take control of a vehicle where the system has determined that driver attention is at least momentarily absent.

Variation 4 may include a product as set forth in any of variations 1 through 4, wherein the motion controller system is constructed and arranged to provide actuation commands to steering, braking, and acceleration systems within a vehicle.

Variation 5 may include a product as set forth in any of variations 1 through 4, wherein the driver monitor system is constructed and arranged to monitor and provide driver attentiveness information to the always-on motion controller.

Variation 6 may include a product as set forth in any of variations 1 through 5, wherein the path planner is constructed and arranged to monitor vehicle lane position, traffic, and provide path planner commands to the always-on motion controller.

According to variation 7, a method may include providing an integrated system including a motion controller system; a path planner system; a driver monitoring system; and an always-on motion controller in operable communication with the path planner system, the driving monitoring system, and the motion controller system. The method may further include receiving information relating to driver attentiveness as determined by the driver monitoring system; receiving actuator status information from the motion control system; receiving predetermined path plans from the path planner system; receiving environmental information such as, but not limited to, detected drivable zones and areas, obstacles, other vehicles, pedestrians, and the like; receiving driver intention and attention interpretation data from the driver monitoring system; determining path plans based on information received from the driver monitoring system; and providing motion controller state data to the path planner system and actuator commands to the motion control system.

Variation 8 may include a method as set forth in variation 7, wherein the always-on motion controller is constructed and arranged to continuously provide an always-on autonomous driving system constructed and arranged to seamlessly take control of a vehicle when the system has determined that driver attention is at least momentarily absent.

Variation 9 may include a method as set forth in any of variations 7 through 8, wherein the motion controller system is constructed and arranged to provide actuation commands to steering, braking, and acceleration systems within a vehicle.

Variation 10 may include a method as set forth in any of variations 7 through 9, further including providing visual and audio flags to the driver monitoring system.

Variation 11 may include a method as set forth in any of variations 7 through 10, wherein the driver monitor system is constructed and arranged to monitor and provide driver attentiveness information to the always-on motion controller.

Variation 12 may include a method as set forth in any of variations 7 through 11, wherein the path planner is constructed and arranged to monitor vehicle lane position, traffic, and provides path planner commands to the always-on motion controller.

Variation 13 may include a method as set forth in any of variations 7 through 12, wherein the method is implemented in an autonomous vehicle.

According to variation 14, a method may include providing an integrated system including a path planner system; a driver monitoring system; a motion controller system; and an always-on motion controller constructed and arranged to continuously provide an always present autonomous driving system constructed and arranged to seamlessly take control of a vehicle when the system has determined that driver attention is at least momentarily absent and wherein the always-on motion controller is in operable communication with the path planner system, the driving monitoring system, and the motion controller system. The method may further include receiving information relating to driver attentiveness as determined by the driver monitoring system; receiving actuator status information from the motion control system; receiving predetermined path plans from the path planner system; receiving environmental information including at least one of detected drivable zones and areas, obstacles, other vehicles, or pedestrians; receiving driver intention and attention interpretation data from the driver monitoring system; determining path plans based on information received from the driver monitoring system; and providing at least one of motion controller state data to the path planner system, visual and audio flags to the driver monitoring system, or actuator commands to the motion control system.

Variation 15 may include a method as set forth in variation 14 wherein receiving information relating to driver attentiveness as determined by the driver monitoring system includes providing information relating to driver attentiveness to the always-on motion controller.

Variation 16 may include a method as set forth in any of variations 14 through 15 wherein receiving actuator status information from the motion control system includes providing actuator status information to the always-on motion controller.

Variation 17 may include a method as set forth in any of variations 14 through 16 wherein receiving predetermined path plans from the path planner system includes providing path plans to the always-on motion controller.

Variation 18 may include a method as set forth in any of variations 14 through 17 wherein receiving environmental information including at least one of detected drivable zones and areas, obstacles, other vehicles, or pedestrians includes providing the environmental information to the path planner system.

Variation 19 may include a method as set forth in any of variations 14 through 18 wherein receiving driver intention and attention interpretation data from the driver monitoring system includes providing driver intention and attention interpretation data to the path planner system.

Variation 20 may include a method as set forth in any of variations 14 through 19 wherein the path planner system is constructed and arranged to determine path plans to the always-on motion controller based on the environmental information and the driver intention and attention interpretation data.

The above description of select variations within the scope of the invention is merely illustrative in nature and, thus, variations or variants thereof are not to be regarded as a departure from the spirit and scope of the invention.

What is claimed is:

1. A product comprising:
an always-on motion controller;
a path planner system;
a driver monitoring system; and
a motion controller system.

2. A product as set forth in claim 1, wherein the always-on motion controller is in operable communication with the path planner system, the driving monitoring system, and the motion controller system.

3. A product as set forth in claim 1, wherein the always-on motion controller is constructed and arranged to continuously provide for an always present autonomous driving system constructed and arranged to control a vehicle where the system has determined that driver attention is at least momentarily absent.

4. A product as set forth in claim 1, wherein the motion controller system is constructed and arranged to provide actuation commands to steering, braking, and acceleration systems within a vehicle.

5. A product as set forth in claim 1, wherein the driver monitor system is constructed and arranged to monitor and provide driver attentiveness information to the always-on motion controller.

6. A product as set forth in claim 1, wherein the path planner is constructed and arranged to monitor vehicle lane position, traffic, and provides path planner commands to the always-on motion controller.

7. A method comprising:
providing an integrated system comprising:
a motion controller system;
a path planner system;
a driver monitoring system; and
an always-on motion controller in operable communication with the path planner system, the driving monitoring system, and the motion controller system;
receiving information relating to driver attentiveness as determined by the driver monitoring system;
receiving actuator status information from the motion control system;
receiving predetermined path plans from the path planner system;
receiving environmental information from at least one vehicle sensor;
receiving driver intention and attention interpretation data from the driver monitoring system;
determining path plans based on information received from the vehicle sensor and the driver monitoring system; and
providing motion controller state data to the path planner system and actuator commands to the motion control system.

8. A method as set forth in claim 7, wherein the always-on motion controller is constructed and arranged to continuously provide an always-on autonomous driving system constructed and arranged to control a vehicle when the system has determined that driver attention is at least momentarily absent; and
wherein the always on motion controller and path planner continuously maintain at least one future predicted path generated during determining path plans based on information received from the at least one sensor and the driver monitoring system, wherein the at least one future predicted path is constructed and arranged to match that which has been interpreted as the driver's intended path or driver intention.

9. A method as set forth in claim 7, wherein the motion controller system is constructed and arranged to provide actuation commands to steering, braking, and acceleration systems within a vehicle.

10. A method as set forth in claim 7, further comprising providing visual and audio flags to the driver monitoring system.

11. A method as set forth in claim 7, wherein the driver monitor system is constructed and arranged to monitor and provide driver attentiveness information to the always-on motion controller.

12. A method as set forth in claim 7, wherein the path planner is constructed and arranged to monitor vehicle lane position and traffic and provide path planner commands to the always-on motion controller.

13. A method as set forth in claim 7, wherein the method is implemented in an autonomous vehicle.

14. A method comprising:
providing an integrated system comprising:
a path planner system;
a driver monitoring system;
a motion controller system; and
an always-on motion controller constructed and arranged to continuously provide an always present autonomous driving system constructed and arranged to seamlessly take control of a vehicle when the system has determined that driver attention is at least momentarily absent and wherein the always-on motion controller is in operable communication with the path planner system, the driving monitoring system, and the motion controller system;
receiving information relating to driver attentiveness as determined by the driver monitoring system;
receiving actuator status information from the motion control system;
receiving predetermined path plans from the path planner system;
receiving environmental information including at least one of detected drivable zones and areas, obstacles, other vehicles, or pedestrians;
receiving driver intention and attention interpretation data from the driver monitoring system;
determining path plans based on information received from at least the driver monitoring system; and
providing at least one of motion controller state data to the path planner system, visual and audio flags to the driver monitoring system, or actuator commands to the motion control system.

15. A method as set forth in claim 14, wherein receiving information relating to driver attentiveness as determined by the driver monitoring system comprises providing information relating to driver attentiveness to the always-on motion controller.

16. A method as set forth in claim 14, wherein receiving actuator status information from the motion control system comprises providing actuator status information to the always-on motion controller.

17. A method as set forth in claim 14, wherein receiving predetermined path plans from the path planner system comprises providing path plans to the always-on motion controller.

18. A method as set forth in claim 14, wherein receiving environmental information including at least one of detected drivable zones and areas, obstacles, other vehicles, or pedestrians comprises providing the environmental information to the path planner system.

19. A method as set forth in claim 18, wherein receiving driver intention and attention interpretation data from the driver monitoring system comprises providing driver intention and attention interpretation data to the path planner system.

20. A method as set forth in claim 19, wherein the path planner system is constructed and arranged to determine path plans to the always-on motion controller based on the environmental information and the driver intention and attention interpretation data.
